(19) United States
(12) Patent Application Publication
(10) Pub. No.: US 2002/0059458 A1
(43) Pub. Date: May 16, 2002

(54) Methods and systems for scalable streaming of images with server-side control

(76) Inventors: Sachin G. Deshpande, Vancouver, WA (US); Renjit Tom Thomas, Vancouver, WA (US)

Correspondence Address: SHARP LABORATORIES OF AMERICA, 5750 NW PACIFIC RIM BLVD, CAMAS, WA, 98607, US

(21) Appl. No.: 09/915,894

(22) Filed: Jul. 25, 2001

Related U.S. Application Data
(63) Continuation-in-part of application No. 09/709,985, filed on Nov. 10, 2000.

(51) Int. Cl. G06F 15/16

(52) U.S. Cl. 709/246; 709/219

(57) ABSTRACT

Embodiments of the present invention provide systems and methods for managing and transmitting image data. Some embodiments are particularly suited to streaming JPEG 2000 images from a web server.

### RELATED REFERENCES

This application is filed as a continuation-in-part of U.S. patent application Ser. No. 09/709,985, titled “Methods and Systems for Transmitting Digital Images,” filed Nov. 10, 2000 by Deshpande et al.

### THE FIELD OF THE INVENTION

Embodiments of the present invention relate to methods and systems for managing and transmitting image data. Some embodiments are particularly suited to streaming JPEG 2000 images from a web server.

### BACKGROUND

In many Internet and network applications, large image files are frequently transferred. These large image files must be transmitted from server to client with accuracy and speed. When connection speeds are not optimal, these images can take an inconveniently long time to download to a client. Using known methods, this extended lag results in high latency or delay before display of the complete image.

Image files can also be problematic when their size, resolution or other attributes are not optimized to the needs of the user.

JPEG 2000 is an image compression standard with the ability to support large images. JPEG 2000 also supports resolution, quality and region-of-interest scalability. Thus, the JPEG 2000 bitstream is scalable. However the server-client protocol to get only part of the JPEG 2000 bitstream is not defined. Details of the JPEG 2000 standard may be accessed by reference to JPEG 2000 Part 1 Final Committee Draft Version 1.0, ISO/IEC JTC 1/SC 29/WG 1 N1646, March 2000 and JPEG 2000 Verification Model 7.0 (Technical Description), ISO/IEC JTC 1/SC 29/WG 1 WG1N1684, April 2000, both of which are incorporated herein by reference.

In JPEG 2000, an image consists of components. An image maybe spatially divided into tiles and tile-components, where each tile is independently coded. A tile-component is then divided into resolutions and sub-bands. A resolution can be partitioned into precincts using rectangular grids. A sub-band is divided into code-blocks where each code-block is an independent coding unit. A precinct may consist of a rectangular region of code-blocks in all sub-bands of the same resolution. The coded data of each code-block can be distributed across one or more quality layers in the codestream. The data representing a specific tile, layer, component, resolution and precinct appears in the codestream in a contiguous segment called a packet.

There are two types of headers in the codestream as shown in FIG. 1. The main header 2 is at the beginning of the codestream. The tile-part headers 4 are found at the beginning of each tile-part 6, where a tile-part is a portion of the codestream that makes up some or all of a tile. The main header 2 provides information about the uncompressed image such as width, height, width of a tile, height of a tile, number of components, bit-depth of each component, etc. The main header 2 also provides the coding style default (COD) (e.g., decomposition levels, progression order, number of layers, code-block size, wavelet filter used, packet partition size, etc.), the quantization default (QCD), as well as some optional information such as region of interest, packed packet headers (PPM), a list of packet lengths (PLM), the length of every tile-part in the codestream (TLM), etc. The main header 2 is followed by one or more tile-parts 6 (each tile-part includes a tile-part header 4 and the tile-part data 8). Similar information can be included in the tile-part header 4 to override the default in the main header 2. The tile-part data 8 consists of packets 10, 12.

The lengths of the main header 2 and each tile-part header 4, and the length of each tile-part 6, can all be easily derived from the main header 2 or tile-part headers 4. In addition, the length of each packet 10, 12 can be obtained from the main header 2 or derived from the packet headers located in the main header 2 or in the codestream 14. Based on this information and the length of code-block contribution information included in each packet header, we can identify the locations/segments of the codestream for a particular code-block, precinct, resolution, component and layer. In fact, an index file can be generated to record this indexing information by parsing the codestream headers, including the main header 2, tile-part headers 4 and packet headers 14. This index file can then be used to facilitate the retrieval of a particular portion of the codestream.

For a given tile, the order in which the packets are interleaved is called the progression order. The interleaving of the packets can progress along four axes: layer, component, resolution and precinct. There are five allowable progression orders in the standard which are signaled by the COD and/or Progressive order change default (POD) markers in the main header 2.

1. Layer-resolution-component-position progressive,

2. Resolution-layer-component-position progressive,

3. Resolution-position-component-layer progressive,

4. Position-component-resolution-layer progressive,

5. Component-position-resolution-layer progressive.

### SUMMARY OF THE INVENTION

Embodiments of the present invention comprise methods and systems that allow customized transmission of image files over a network. Embodiments of the present invention provide for scalable image resolution, quality scalability including signal-to-noise ratio (SNR) scalability, region-of-interest (ROI) selection and other features.

In some embodiments of the present invention, a user may select quality scalability thereby allowing a client application to begin rendering an image before the image is fully transmitted. This may be performed by rendering an image coarsely and reducing the coarseness of the image progressively as data is received.

Some embodiments of the present invention may allow for region-of-interest (ROI) scalability wherein a user may select a region-of-interest that may be transmitted alone or given priority in the image transmission process. A user may select a ROI to be viewed and an embodiment of the present invention may transmit only that area to the user thereby decreasing latency. Alternatively, a user may select a ROI and another embodiment of the present invention will select that ROI area for priority transmission to be followed by transmission of the remainder of the image. In this manner, a ROI may be viewed more quickly and, if desired, another portion or the remainder of the image may be viewed after inspection of the ROI.

Some embodiments of the present invention comprise methods and systems for server-side control of image streaming. Some of these embodiments may comprise an index file. Other embodiments may comprise methods of server-side parsing of image files. Server-side scripts (CGI), servlets or similar server-side objects may be used in these embodiments.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram showing elements of an exemplary image file structure;

FIG. 2 is a diagram of a computer screen displaying a thumbnail interface of some embodiments of the present invention;

FIG. 3 is a diagram of a computer screen displaying a resolution scalability function on a thumbnail interface of some embodiments of the present invention; and

FIG. 4 is a diagram of a computer screen displaying a full resolution image on a thumbnail interface of some embodiments of the present invention.

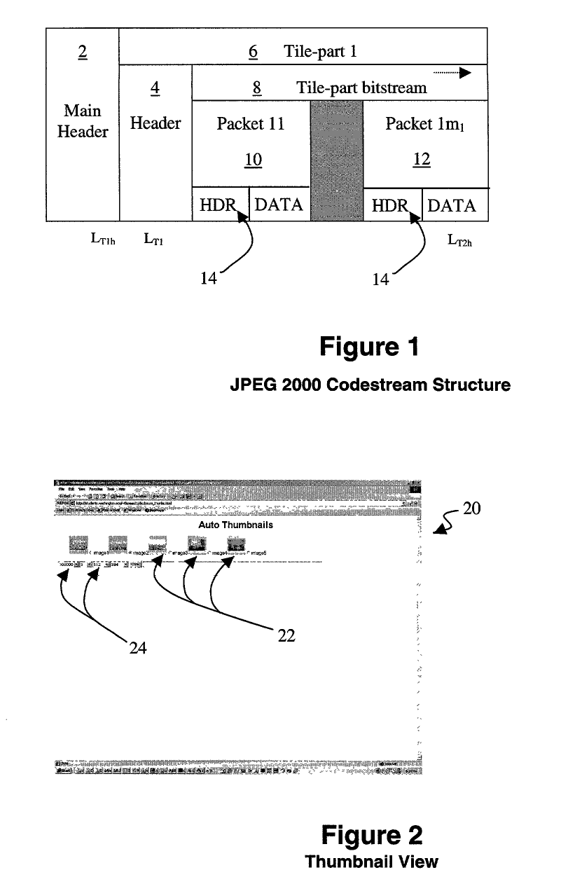

### DETAILED DESCRIPTION

The currently preferred embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention are explained in reference to a specific embodiment which employs an HTTP protocol for streaming images in the JPEG2000 format. While this is used as a primary example, other protocols and image formats may be used in embodiments of the present invention.

In some embodiments, the above described features and/or other features may be implemented using a client application which downloads the target image at a reduced resolution and displays that image as a “thumbnail” for user manipulation, reference and input such as ROI selection and other selection. Once the thumbnail has been downloaded and displayed, a user may select a portion of the image for display at a resolution higher than that of the thumbnail. A user may select a ROI on the thumbnail or on a higher-resolution image using many known input device methods. Generally, a rectangular region will be delineated by a series of inputs, such as mouse clicks, and the client application will request the portion of the image corresponding to the designated region of interest. In this manner, a portion of the image may be displayed without waiting for display of the entire image.

Some embodiments of a client application may provide for selection of image resolution. Typically, for large, high-resolution images, there will be a range of resolutions between the maximum image resolution and a minimum thumbnail resolution. These embodiments will allow a user to select an optimum resolution below the maximum image resolution which will reduce latency.

A client application of embodiments of the present invention may also allow a user to select whether quality scalability is enabled. When enabled, quality scalability can render relevant image details prior to complete image transmission thereby allowing a user to make image decisions prior to complete transmission of the image. Quality scalability may be applied to the thumbnail used for ROI selection as well as the target image.

In a parent application, the inventor introduced an index file concept which allows a client to make intelligent HTTP requests to obtain required portions of an image file bitstream, such as a JPEG 2000 bitstream, from a web server. Embodiments of the present invention may utilize index file methods while other embodiments may operate without index files. Embodiments of the present invention comprise image data streaming methods and systems which employ server side parsing to customize and modify the image data. The architectures of these embodiments may be web based and may use HTTP protocols. These methods can be used without any explicit index file.

Known methods include a set of application programming interfaces (APIs) for random access of segments of JPEG2000 files and an architecture for cache management, network packetization and packet loss recovery for JPEG2000 files. There are several drawbacks of this approach. It needs a proprietary server to support the above features, whereas embodiments of the present invention may work with any standard HTTP 1.1 web server or other servers configurations. Some embodiments may be used with any HTTP 1.1 server supporting byte-ranges. Several commercial and free HTTP servers exist which are compatible with embodiments of the present invention.

HTTP runs on top of TCP/IP, which supports reliable packet delivery. Caching is also supported by HTTP. Unlike audio and video data, which have real-time properties and thus can not be optimally transmitted using TCP/IP, the JPEG2000 images can be transmitted using such a reliable delivery mechanism. Whereas error concealment and error resilience are active research areas for video and audio data, an image (i.e., JPEG2000) typically needs to be transported reliably and any packet loss is better handled by re-transmission. Accordingly, embodiments of the present invention utilize web server based streaming for JPEG 2000 images. This allows easy deployment since standard web servers can host the JPEG2000 images.

Embodiments of the present invention may employ server side streaming to achieve their functionality. Some embodiments may use one or more index files which reside at the server. These index files do not need to be downloaded to the client. Other embodiments may have no index file and may use server side parsing of image bitstreams such as JPEG 2000 bitstreams. In some of these embodiments, client requests may be sent to a server side script (CGI)/a servlet or any similar server side object.

Some embodiments of the present invention using server side streaming can choose to use an index file or do on-the-fly parsing, thus avoiding the use of an index file.

Client side parsing methods have the advantage of not needing an index file. However, this comes at the expense of extra overhead of reading a fixed number of bytes every time. Since the client bandwidth is generally restricted, this can be inefficient for certain bandwidth-constrained clients. In some embodiments of the present invention, a server side script may be used to handle streaming. Some of these embodiments may employ an index file which may be a separate file from the image file or comprised within the image file such as a JPEG2000 image file. Other embodiments may perform on-the-fly parsing of the image file at the server side to identify required portions of the bitstream to be streamed to the client.

A client can send requests to a server using either GET or POST HTTP requests. These methods determine how the request data is sent to the server. In the GET method, the input values from the client may be sent as part of the URL, using URL encoding. With POST, data is sent as an input stream to the script. The client requests can include the parameter values, which are derived, based on user interaction. These values can be, for example, the resolution level in which the user is interested and/or a region-of-interest (ROI).

Quality scalability can be supported explicitly by allowing the user to select a particular quality, or implicitly by decoding the streamed data for a particular user specified resolution and ROI as the data starts arriving from the server. This implicit quality scalability will result in a gradual build-up from coarse to fine quality of the selected resolution and/or ROI part of the image. Some examples of requests that may be made with embodiments of the present invention are shown below:

1. Client request to get thumbnail (lowest resolution) of flower image, using HTTP GET method:

http://www.imageshost.com/cgi/j2kserver?IMG=/images/flower1. jp2&RES=1

2. Client request for resolution 4 of a rectangular ROI with top left co-ordinates (10,24) and ROI (height, width)=(78,86) of image flower, using HTTP GET method:

http://www.imageshost.com/cgi/j2kserver?IMG=/images/flower1. jp2&RES=4&ROI=10,24,78,86

These requests may be generated automatically at the client, based on user interaction through a suitable user interface. Client software may comprise a plug-in or a custom control embedded in the web browser, a java applet, and/or a client helper application.

After receiving the request from the client, the server script can use an index file for the particular image or do on-the-fly parsing from the JPEG2000 image file to find out which part of the bitstream needs to be transferred to the client and then stream the required portion to the client. The server may be running a Common Gateway Interface (CGI) script, a Java servlet or any similar server-side technology. The response sent from the CGI script or servlet could be a standard HTTP response. One possible way would be to send a HTTP 206 partial content response. The following two examples correspond to the server side responses to the above two example requests from the client.

1. Server finds out by using the index file or by on-the-fly parsing of JPEG2000 image that the thumbnail image data is contained in the bytes [1470,10064] of the JPEG2000 bitstream, and sends the following response for the thumbnail request from the client:

HTTP/1.1 206 Partial Content

Date: Fri, Jul. 7, 2000 22:38:58 GMT

Server: Apache/1.3.12 (Win32)

Last-Modified: Wed, Jul. 5, 2000 19:04:01 GMT

ETag: “0-fffb-396386a1”

Accept-Ranges: bytes

Content-Length: 8595

Content-Range: bytes 1470-10064/655345

Content-Type: image/jpeg2000

CRLF

[image data bytes 1470-10064]

2. Server finds out from the index file or by parsing on-the-fly that the ROI part with top left co-ordinates (10,24) and ROI (height, width)=(78,86) at resolution 4 corresponds to the byte-ranges 123-171, 175-200, 205-300, 345-346, 400-500, 555-666, 667-800, 900-1000, 2500-2567, 2890-3056, 5678-9000, 10000-12004, 12050-12060, 15600-15605, 17000-17001, 17005-17010, 17050-17060, 17800-17905, 20000-20005 of JPEG2000 bitstream and sends the following response to the client. A JPEG2000 bitstream is byte-aligned for the individual independent units. In non-byte-aligned embodiments, the request may still be at the byte granularity and the response can be parsed to get rid of the irrelevant bits.

HTTP/1.1 206 Partial Content

Date: Tue, Aug. 1, 2000 16:38:35 GMT

Server: Apache/1.3.12 (Win32)

Last-Modified: Wed, Jul. 5, 2000 19:04:01 GMT

ETag: “0-fffb-396386a1”

Accept-Ranges: bytes

Content-Length: 8350

Content-Type: multipart/byteranges; boundary=3986fd0b22d

CRLF

CRLF

- - - 3986fd0b22d

Content-type: image/jpeg2000

Content-range: bytes 123-172/655345

CRLF

[image data bytes 123-171]

- - - 3986fd0b22d

Content-type: image/jpeg2000

Content-range: bytes 175-200/655345

CRLF

[image data bytes 175-200]

- - - 3986fd0b22d

- - - 3986fd0b22d

Content-type: image/jpeg2000

Content-range: bytes 20000-20005/655345

CRLF

[image data bytes 20000-20005]

- - - 3986fd0b22d-

It should be noted that an early draft of the byteranges specification for HTTP used a media type of multipart/x-byteranges. A number of older browsers and servers were coded to use this, which is not strictly compatible with the HTTP/1.1 version. Once the server determines what portions to send and sends the data, the client receives the streamed data, decodes and displays it.

Quality scalability and region-of-interest (ROI) scalability can be achieved similarly by obtaining the required portions of an image file such as a JPEG2000 bitstream.

Streaming Selected Portions of the Codestream

Since a JPEG2000 codestream is well structured, it is possible to retrieve some portion of the codestream for a particular interest. Some typical applications are resolution scalability, quality scalability and region of interest streaming. The locations of the corresponding portions of the codestream for these applications are described below.

Resolution Scalability. If the progression order follows Order 2 or Order 3, then the data for a particular resolution will be a contiguous segment in the codestream. If the progression order follows Order 1, then the data for a particular resolution will be distributed over several separate contiguous segments (one in each quality layer) in the codestream. If the progression order follows Order 4 or 5, then the data for a particular resolution will again consists of several separate contiguous segments in the codestream, with one segment in each precinct and each component.

SNR (quality) Scalability. It is also relatively easy to achieve SNR scalability, especially when the codestream follows the first progression order. For the other progression orders, the data for a particular quality layer is distributed over several separate contiguous segments in the codestream. Their locations can be obtained from the index file or by doing on-the-fly parsing of the bitstream.

Region of Interest (ROI) Streaming. Region of interest streaming is more computationally involved as compared to the above two cases. For an arbitrary region in the spatial domain, we need to trace how each coefficient and pixel value is reconstructed in the inverse wavelet transform, and find the corresponding region in each sub-band that contributes to the reconstruction of the ROI. The precincts and code-blocks that are needed to reconstruct the ROI can then be identified. The compressed data for these precincts and code-blocks can then be located and retrieved at the server side for streaming.

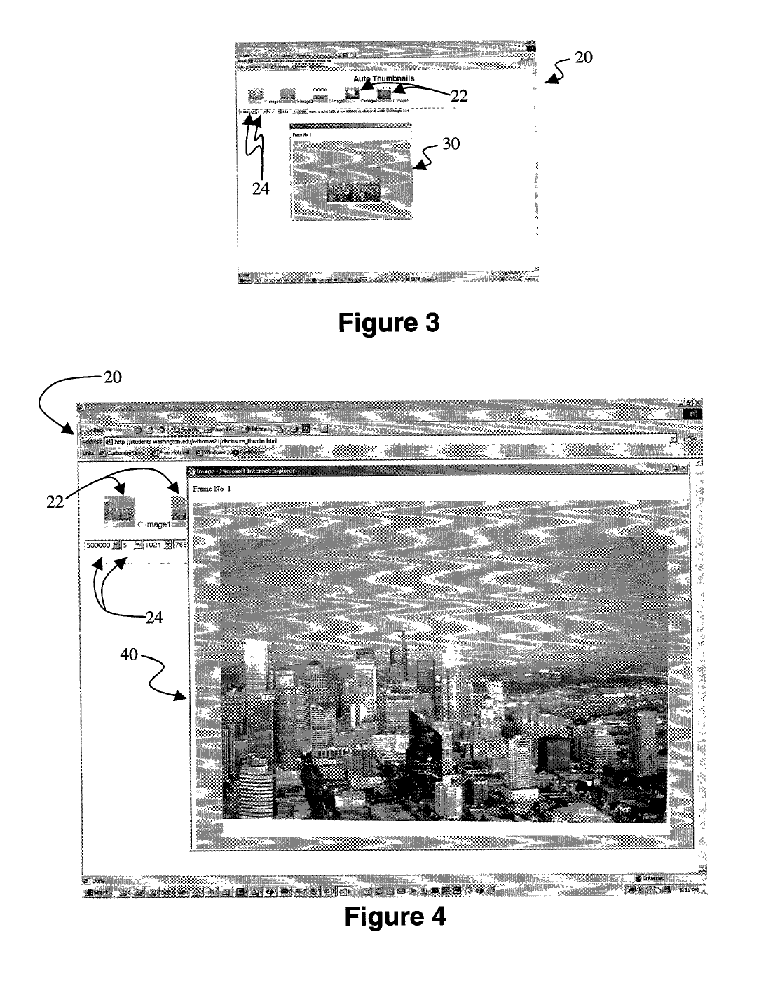

Some embodiments of the present invention implement server-side, on-the-fly or index file-based streaming for JPEG 2000 images. An example of these embodiments is shown in FIG. 2 where the initial appearance of a web page 20 with thumbnails 22 is shown. Thumbnails 22 may be automatically generated by the server-side, on-the-fly or index file-based streaming as described above. Buttons, drop-down menus, dialog boxes and other user interface controls 24 may be used to obtain user data. User interface controls 24 may be used to obtain user preferences regarding image resolution, quality scalability and other data. Thumbnails 22 may be used to select a particular image or portion thereof. A region-of-interest (ROI) may be selected by clicking and dragging a particular area on one of the thumbnail images. Once user preferences are identified, the image may be streamed to the client in the preferred format. As shown in FIG. 3, an image 30 may be streamed at a prescribed resolution that is lower than the maximum resolution available for the image. This can save transmission time and resources. The user may also select to view the image at the highest available resolution 40 as shown in FIG. 4. Intermediate steps in the decoding typically utilize large amounts of resources (e.g. memory); however these are released once the decoding is over. The current web browsers also typically may put restrictions on the number of simultaneously open connections to the server. To take care of these issues, some embodiments take advantage of the fact that the different instances of the same applet class are running in the web browser. The execution of the applets is then serialized by locking and releasing the shared resources.

Some embodiments use HTTP/1.1 protocol to stream JPEG2000 images from a web server. Other embodiments may also use other similar protocols and similar image formats.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for image transmission, said method comprising the acts of:
hosting an image file on a server;
requesting said image file from a client;
parsing said image file on said server to determine a representative part of said image;
transmitting said representative part of said image file to said client;
selecting a customization of said image through a client interface on said client;
transmitting said customization information from said client to said server;
parsing said image file on said server to determine image data associated with said customization and
transmitting said image data associated with said customization to said client.

2. The method of claim 1 wherein said representative part of said image file is a low-resolution version of said image.

3. The method of claim 1 wherein said client interface prompts a user for image customization data.

4. The method of claim 1 wherein said selecting a customization comprises selecting data from the group consisting of quality data, scalability data, resolution data and region-of-interest (ROI) data.

5. The method of claim 1 wherein said selecting a customization comprises displaying a thumbnail image to a user and allowing a user to select customization characteristics by interaction with said thumbnail image.

6. The method of claim 1 wherein said image file is a JPEG 2000 file.

7. The method of claim 1 wherein said transmitting uses an HTTP transmission protocol.

8. The method of claim 1 wherein said selecting a customization of said image comprises selecting an image resolution below the maximum resolution available for said image.

9. The method of claim 1 wherein said transmitting said customization data comprises streaming said customization of said image to said client.

10. The method of claim 1 wherein the size of said representative part is relative to the bandwidth of the connection between said server and said client interface.

11. The method of claim 1 wherein said representative part comprises metadata comprising data selected from the group consisting of image quality data, scalability data, resolution data and ROI data.

12. The method of claim 1 wherein said client caches data recieved from said server.

13. A method for interactive customized image transmission, said method comprising the acts of:
hosting an image file on a server;
requesting said image file from a client;
transmitting a thumbnail version of said image file to said client;
selecting a customized version of said image through user input at said client;
transmitting said customized version information from said client to said server;
reading and parsing said image file at said server to determine image data required for said customized version; and
transmitting said image data required for said customized version to said client.

14. The method of claim 13 further comprising reading and parsing said image file to determine thumbnail image data required to communicate said thumbnail image.

15. The method of claim 13 wherein said selecting a customized version of said image comprises selecting an image resolution below the maximum resolution available for said image.

16. The method of claim 13 wherein said selecting a customizatized version of said image comprises selecting quality scalability.

17. The method of claim 13 wherein said selecting a customization of said image comprises selecting a region of interest on said image.

18. The method of claim 13 wherein said image file is a JPEG 2000 image file.

19. The method of claim 13 wherein said transmitting employs a HTTP transmission protocol.

20. An apparatus for interactive customized image transmission, said apparatus comprising:
a server having an image file stored thereon;
a parser on said server for parsing said image file and determining what image file data is required to communicate various customized versions of said image file;
a client having a client image interface;
wherein said client image interface enables a user to request a customized version of said image file and said parser on said server has the ability to determine what image data is required to communicate said customized version and transmit said image data to said client.

21. An image server enabling interactive customized image transmission, said server comprising:
storage for storing at least one image file;
a receiver for receiving requests from a client for customized versions of said at least one image file;
a reader/parser for reading and parsing said image file and determining what image data is required to render said customized versions of said image file; and
a sender for sending said customized image data to said client.

22. A computer-readable medium comprising instructions for creating a customization of an image file, said instructions comprising the acts of:
storing at least one image file;
receiving requests from a client for customized versions of said at least one image file;
reading and parsing said image file and determining what image data is required to render said customized versions of said image file; and
sending said customized image data to said client.

23. A computer data signal embodied in an electronic transmission, said signal having the function of creating an image index file, said signal comprising instructions for:
storing at least one image file;
receiving requests from a client for customized versions of said at least one image file;
reading and parsing said image file and determining what image data is required to render said customized versions of said image file; and
sending said customized image data to said client.
